(19) United States
(12) Patent Application Publication
(10) Pub. No.: US 2007/0281500 A1
(43) Pub. Date: Dec. 6, 2007

(54) Card edge connector

(75) Inventor: Zhen-Hua Wang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/809,338

(22) Filed: May 31, 2007

(30) Foreign Application Priority Data
May 31, 2006 (CN) 200610085858.5

(51) Int. Cl. H01R 12/00

(52) U.S. Cl. 439/62

(57) ABSTRACT

A card edge connector for a daughter board comprises a connector body and a fastener. The fastener has a base portion with a pair of latching arms for latching the daughter board, a movable portion mounted on the base portion and being able to move in a top-to-bottom direction, a spring respectively abutting against the base portion and the movable portion at opposed ends thereof and a locking equipment. The daughter board inserts into the connector body and is downwardly pressed toward the fastener; then the movable portion of the fastener moves downwardly and brings the latching arms rotating outwardly to latch the daughter board. Then, the locking equipment locks the movable portion to keep the daughter board in a reliably electrical connecting with the card edge connector and a print circuit board.

### BACKGROUND OF THE INVENTION

1. Field of the Invention

The present invention relates to a card edge connector which has a latching equipment.

2. Description of Related Art

A card edge connector usually has a latching equipment to keep a daughter board engaging with the card edge connector, such a latching equipment is mounted to a print circuit board, simultaneity together with a connector body of the card edge connector. The daughter board inserts into the connector body, and then is pressed downwardly toward the latching equipment to be locked by the latching equipment. User needs to actuate an unshackling portion formed on the latching equipment to release the daughter board from the latching equipment. Since the latching equipment is small component, the unshackling portion is much more smaller, it is not easy for user to actuate the unshackling portion.

Hence, an improved connector is required to overcome the disadvantages of the prior art.

### SUMMARY OF THE INVENTION

An object of the present invention is to provide a card edge connector with a fastener which user can easily operate.

Accordingly, to achieve above-mentioned object, a card edge connector for a daughter board comprises a connector body and a fastener, the connector body has an insulating housing defining a receiving slot and a plurality of contacts retained in the insulating housing; a fastener has a base portion, a pair of latching arms, a movable portion mounted on the base portion, a spring respectively abutting against the base portion and the movable portion at opposed ends thereof and a locking equipment. The movable portion is able to move in a top-to-bottom direction and defines an original position and a locking position, a movement of the movable portion from the original position to the locking position brings the latching arms rotating, and the locking equipment locks the movable portion at the locking position.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled, perspective view of a card edge connector of the present invention with a daughter board inserted therein;

FIG. 2 is similar with the FIG. 1, but taken from a bottom view;

FIG. 3 is an exploded, perspective view of the card edge connector;

FIG. 4 is an exploded, perspective view of a fastener;

FIG. 5 is a partially exploded, perspective view of the fastener;

FIG. 6 is a cross section view of the fastener, showing the fastener engaging with a daughter board, but not locking the daughter board;

FIG. 7 is another a cross section view of the fastener, showing the fastener locking the daughter board; and

FIG. 8 is an expanding planar view of a track formed on the fastener.

### DETAILED DESCRIPTION OF THE INVENTION

Reference will now be made in detail to the preferred embodiment of the present invention.

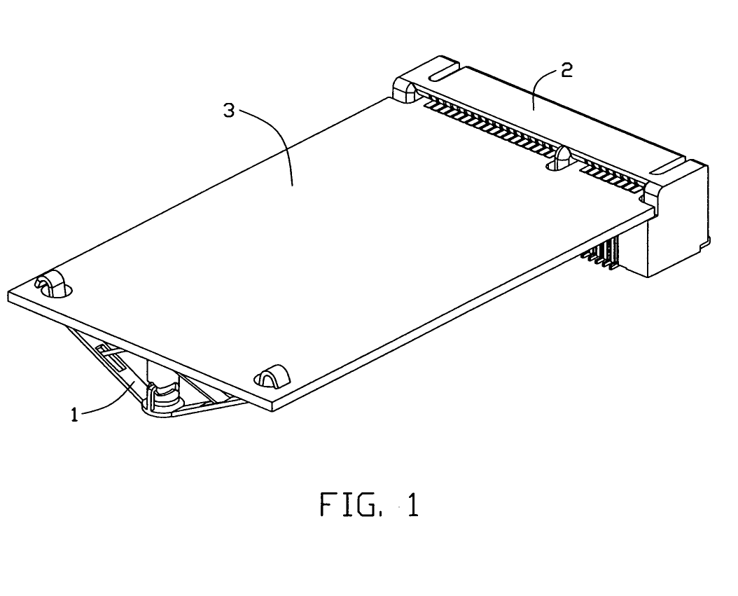

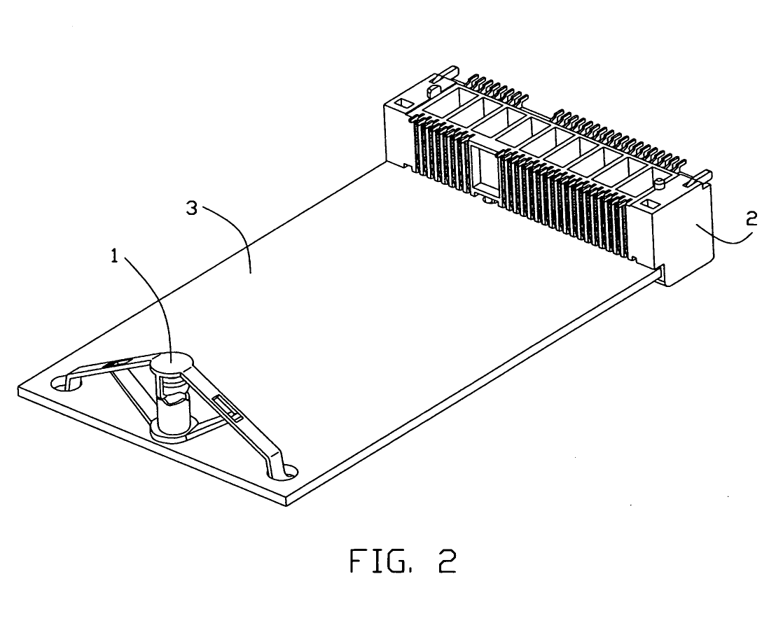

Referring to FIGS. 1 to 3, a card edge connector comprises a fastener 1 and a connector body 2 separately mounted on a print circuit board (not shown), a daughter board 3 inserts into the connector body 2 and is fixed by the fastener 1 to establish a steady electrically connecting with the print circuit board. The connector body 2 has a heightened longitudinal insulating housing 20 and a plurality of contacts 22 mounted on the insulating housing 20. The insulating housing 20 defines a receiving slot 21 for the daughter board 3 on an upper portion thereof along a longitudinal direction, and a plurality of contact receiving channel (not labeled) formed on a top and a bottom sides of the receiving slot 21 and passing through a bottom face of the insulating housing 20 to receive the contacts 22. The daughter board 3 has an insertion portion 32 with a width corresponding to the receiving slot 21 which is an end of the daughter board 3, the insertion portion 32 is formed with a plurality of conductive pad 31 respectively on a top and bottom surfaces thereof and defines a notch 33 for engaging with a key 23 formed on the insulating housing 20 to ensure the daughter board 3 correctly inserts into the receiving slot 21. The daughter board 3 further defines a pair of latching holes 34 near two lateral sides on the other end thereof opposed to the inserting potion 32.

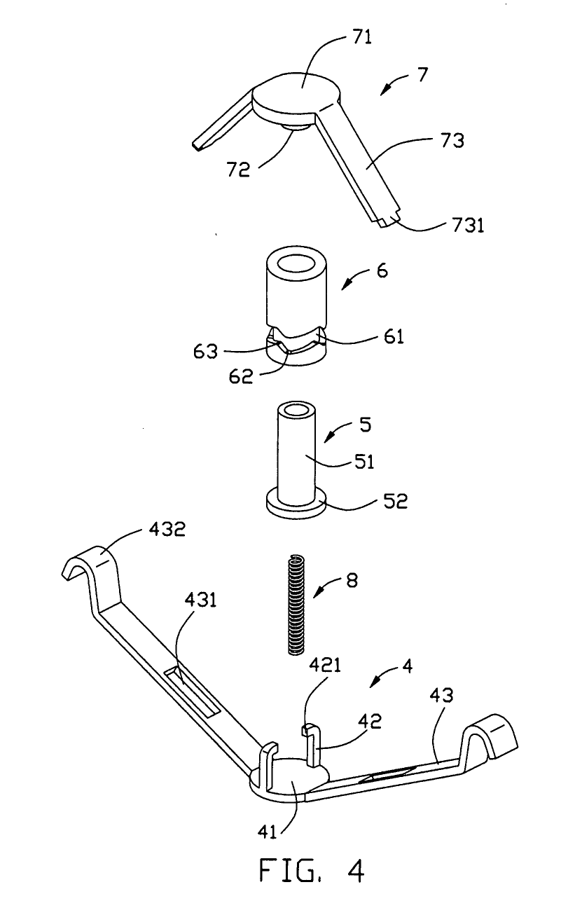

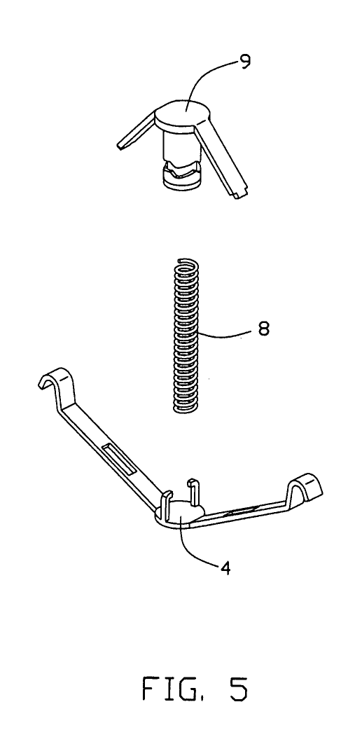

Referring to FIGS. 4 and 5, showing an exploded view of the fastener 1, the fastener 1 comprises a base portion 4, a linking portion 5, a rotating portion 6, a supporting portion 7 and a spring 8.

The base portion 4 has a round center portion 41, a pair of engaging fingers 42 vertically and upwardly extending from two opposed edges of the center portion 41, and a pair of latching arms 43 respectively extending outwardly and upwardly from another opposed edges of the center portion 41. The latching arms 43 and the center portion 41 together form an approximate V-shaped, a linking line of the two engaging fingers 42 is perpendicular to a linking line of the two latching arms 43 in present embodiment. The engaging finger 42 is formed with a free end 421 which extends horizontally toward a center of the center portion 41. The latching arm 43 has a through slot 431 in a middle part thereof and a clasp portion 432 curved outwardly and downwardly on a free end thereof.

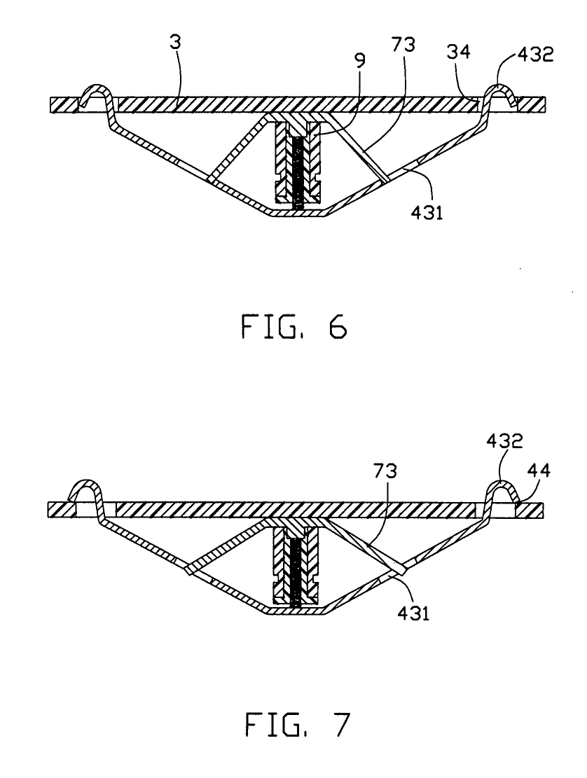

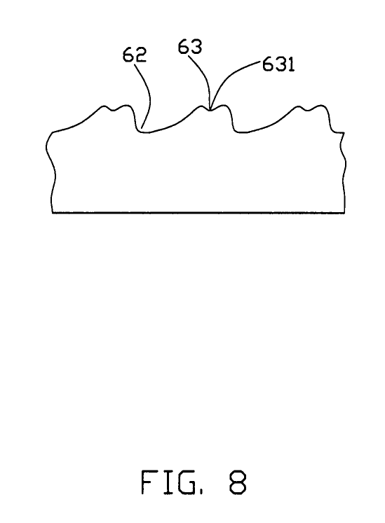

The linking portion 5 is a circular tube-liked, which defines a though circular passage therein, the linking portion 5 has a main body 51 and a dilated portion 52 on a bottom part thereof. The rotating portion 6 is also in a tube-like shaped, and can surround the main body 51 of the linking portion 5. The rotating portion 6 defines a continual track 61 inwardly recessed from a circumference thereof. The track 61 has troughs and wave crests, referring to FIG. 6, a first position 62 points to the trough and a second position 63 points to a recess 631 of the wave crest.

The supporting portion 7 has a top round plane 71, a position portion 72 protruding from a center of a bottom face of the top round plane 71, and two branches 73 extending outwardly and downwardly from two opposed edges of the top round plane 71. The branch 73 has a narrow free end 731 for engaging with the through hole 431.

When assembling the fastener 1, firstly, the linking portion 5 is upwardly inserted into the rotating portion 6, the main body 51 is received in the rotating portion 6, top surfaces of the main body 51 and the rotating portion 6 being in same plane, the dilated portion 52 support the linking portion 5; Then, the supporting portion 7 downwardly assembles to the liking portion 5, the position portion 72 inserts into and interferentially engages with the main body 51 received in the rotating portion 6 to retain the supporting portion 7 with the linking portion 5, the rotating portion 6 loosely surrounds the linking portion 5 and is able to rotate relative to the linking portion 5 and the supporting portion 7; After this process, referring to FIG. 5, a movable/retractable portion 9 is formed, which is composed of the linking portion 5, the rotating portion 6 and the supporting portion 7 and is able to move in a top-to-bottom direction; Finally, the spring 8 upwardly inserts into the main body 51, mount the movable portion 9 together with the spring 8 on the base portion 4, the free ends 421 of the engaging fingers 42 are positioned in the continual track 61 of the rotating portion 6, the branches 73 abuts the latching arms 43 with the free ends 731 positioned in the through slots 431 of the latching arms 43, and the spring 8 respectively abuts against the center portion 41 of the base portion 4 and the supporting portion 7.

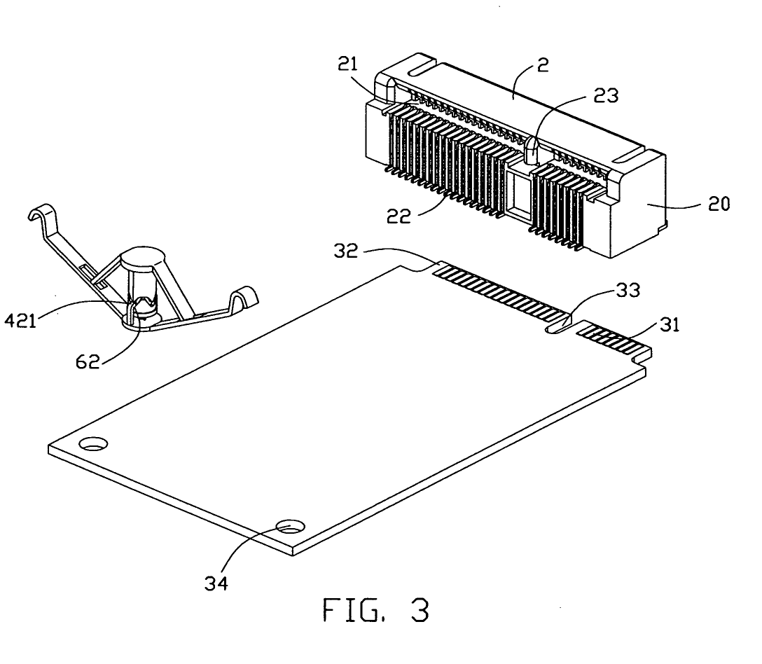

Conjoined with FIG. 3, the fastener 1 and the connector body 2 are respectively mounted on a print circuit board by soldering, the fastener 1 is in an original position, the free ends 421 are at the first portion 62, the free ends 731 of the branches 73 near inner sides of the through slots 431 which is close the center portion 41. When installing the daughter board 3, plug the insertion portion 32 of the daughter board 3 into the receiving slot 21 of the connector body 2, and downwardly press the other end of the daughter board 3 to make the daughter board 3 rotate downwardly relating to the connector body 2 and toward the fastener 1 till the daughter board 3 touches the supporting portion 7 of the fastener 1, as shown in FIG. 6, the fastener 1 is at the original position, the clasp portion 432 is partially received in the latching holes 34 of the daughter board 3.

Then further press the daughter board 3, the movable portion 9 is forced to downwardly move. The free ends 421 of the engaging fingers 42 is forced to move from the first position 62 to the second position 63 and lock the movable portion 9 when achieving the recess 631 of the wave crest, referring to FIG. 7, at this moment the movable portion 9 achieves a locking position, so the engaging fingers 42 and the continual track 61 can be referred as a locking equipment, during this process, the spring 8 is compressed; and then, the latching arms 43 will upwardly moves relative to the daughter board 3 to bring the clasp portions 432 passing through the latching holes 34, and the latching arms 43 will synchronously rotates outwardly by downward force of the branches 73 of the supporting portion 7 to make the clasp portions 432 lock an edge of the latching holes 34 of the daughter board 3. So an abutting face 44 of the clasp portion 432 presses a top surface of the daughter board 3, as shown in FIG. 7, a distance between a bottom surface of the movable portion 9 and a top surface of the center portion 41 of the base portion 4 is withheld for further downward movement of the movable portion 9. Understandably, the reciprocal structure of the fastener is similar to that used in the retractable ball pen of the office supply, thus no detailed description being required herewith.

When releasing the daughter board 3 from the fastener 1, downwardly press the daughter board 3 and the movable portion 9 again, the clasp portion 432 leaves the recess 631 and is free, then, by a resilience of the spring 8, the movable portion 9 upwardly moves and brings the latching arms 73 rising. So, the latching arms 431 are able to rotate inwardly to return an original state by themselves resilience and release the daughter board 3. After that the daughter board 3 is released from the fastener 1 and moves through the clasp portion 432, following the movable portion 9 pushed upwardly by the spring 8. In fact, the fastener 1 of the card edge connector 100 can lock and release the daughter board 3 by easy operation.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card edge connector comprising:
a connector body having an insulating housing defining a receiving slot and a plurality of contacts retained in the insulating housing;
a fastener having a base portion, a pair of latching arms, a movable portion mounted on the base portion, a spring respectively abutting against the base portion and the movable portion at opposed ends thereof and a locking equipment, the movable portion being able to move in a top-to-bottom direction and defining an original position and a locking position, a movement of the movable portion from the original position to the locking position bringing the latching arms rotating, and the locking equipment locking the movable portion at the locking position.

2. The card edge connector as described in claim 1, wherein the movable portion is downwardly pressed again at the locking position, the movable portion is released by the locking equipment and upwardly moves toward the original position by a resilience of the spring, and then the latching arms return to an original state.

3. The card edge connector as described in claim 2, wherein the locking equipment comprise a track defined on the movable portion and a pair of fingers disposed on the base portion, the finger is able to move along the track and locks the movable portion.

4. The card edge connector as described in claim 3, wherein the movable portion comprise a rotating portion and a supporting portion assembling upon the rotating portion, the track of the locking equipment is a continual circular groove defined on circumference of the rotating portion, and the rotating portion rotates following the movement of the movable portion.

5. The card edge connector as described in claim 4, wherein the latching arms are formed on the base portion, and a pair of branches are formed on the supporting portion to respectively abutting against the latching arms.

6. The card edge connector as described in claim 5, wherein the latching arm defines a through slot, the branch has a narrow free end inserting into the through slot, when the movable portion moves downwardly, the branch forces the latching arms to rotate outwardly and move along the through slot.

7. The card edge connector as described in claim 5, wherein the base portion has a round center portion, the fingers vertically and upwardly extends from two opposed edges of the center portion, and the latching arms extends outwardly and upwardly from another opposed edges of the center portion.

8. The card edge connector as described in claim 5, wherein the supporting portion has a round plane, and the branches extend outwardly and downwardly from opposed edges of the center portion to abut against the latching arms.

9. The card edge connector as described in claim 5, wherein the movable portion further has a tube-like linking portion formed with a main body and a dilated portion at a bottom part thereof, the main body is upwardly received in the rotating portion, the supporting portion has a position portion protruding from a bottom face thereof to fix with the main body of the linking portion, the spring is received in the main body with an end abutting against the position portion and the other end abutting against the base portion.

10. An electrical connector assembly comprising:
a printed circuit board defining at least one through hole therein;
a fastener and an electrical connector respectively mounted on two opposite regions of the printed circuit board;
an electrical connector mounted upon the printed circuit board; and
a daughter board having one end coupled to the electrical connector and the other end coupled to the fastener; wherein
said fastener includes a hook engageable within the through hole, and a retractable portion reciprocally moveable between a first position where the hook is engaged within the through hole in tensional relationship therebetween, and a second position where the hook is disengaged from the through hole in a relaxed relationship therebetween.

11. The connector assembly as claimed in claim 10, wherein the retractable portion is in relaxation at the first position and in tension at the second position.

12. The connector assembly as claimed in claim 10, wherein said fastener is essentially fully hidden under the daughter board except the said hook.

13. The connector assembly as claimed in claim 10, wherein the fastener includes a base portion with a latching arm, and the hook is located at a distal end of said latching arm.

14. The connector assembly as claimed in claim 10, wherein said retractable portion further includes a branch engaged with the latching arm for guidable movement therebetween.

15. A method of operating a daughter board in an electrical connector, comprising:
providing a printed circuit board with an electrical connector and a fastener mounted on two spaced area thereon; and
providing a daughter board with one end coupled to the electrical connector and the other end coupled to the fastener; wherein
the fastener includes a hook engaged with the daughter board when the daughter board is coupled to the fastener, and a retractable portion reciprocally moveable between a first position where the hook is engaged with the daughter board in tensional relationship therebetween, and a second position where the hook is disengaged from the daughter board in a relaxed relationship therebetween.

16. The method as claimed in claim 15, wherein when coupled, said fastener is essentially fully located under the daughter board except the hook.

17. The method as claimed in claim 16, wherein the engagement/disengagement between the daughter board and the hook results from downward pushing on the daughter board to up and down activate the retractable portion.

18. The method as claimed in claim 15, wherein the fastener includes a base portion with a latching arm, and the hook is located at a distal end of said latching arm.

19. The method as claimed in claim 18, wherein, with regard to the base portion, the retractable portion is in relaxation at the first position and in tension at the second position.

20. The method as claimed in claim 15, wherein the printed circuit board defines a through hole through which the hook extends.
